(19) United States
(12) Patent Application Publication
(10) Pub. No.: US 2008/0018736 A1
(43) Pub. Date: Jan. 24, 2008

(54) Mobile multimedia display apparatus

(75) Inventor: De-Hong Sun, Zhonghe City (TW)

Correspondence Address: TROXELL LAW OFFICE PLLC, 5205 LEESBURG PIKE, SUITE 1404, FALLS CHURCH, VA, 22041, US

(73) Assignee: Jie-Yi Co., Ltd.

(21) Appl. No.: 11/490,169

(22) Filed: Jul. 21, 2006

(51) Int. Cl. H04N 7/18

(52) U.S. Cl. 348/143

(57) ABSTRACT

A mobile multimedia display apparatus comprises at least one elevating device having a plurality of monitors attached thereon for adjusting the height of the monitors by using the elevating device such that the related message can be outward transmitted via the monitors.

### FIELD OF THE INVENTION

The present invention relates to a mobile multimedia display apparatus adapted to a large-scale location for wedding feast, year-end dinner, election dinner, graduation dinner, etc.

### BACKGROUND OF THE INVENTION

Marriage is very important in human life. To share the newlyweds' gladness with their kinfolks and friends, the wedding feast is usually celebrated under the awning built near their house for cooking the dishes by chefs or at the restaurant on the wedding day.

If the wedding feast is decided to be celebrated at the restaurant, various restaurant owners always do their best to get the newlyweds' favour. The countermen commonly perform torch or dry ice show in the beginning of the wedding feast, and the projector displays the newlyweds' living photos man and boy and their wedding photos.

Even these shows make the gusts feel everything fresh and new, the landform of the restaurant may limit the guests' eyeshots, causing some of them unable to distinctly watch the shows or programs displayed on the projector. As a result, the restaurant owner's painstaking effort gets no response from these guests.

Whereas the foregoing description, the present inventor makes diligent studies in providing the consumers with a mobile multimedia display apparatus that is easily viewable.

### SUMMARY OF THE INVENTION

It is a main object of the present invention to provide a mobile multimedia display apparatus that is not limited by the landform and enables every guest to easily, distinctly receive the messages from the sponsor.

In order to achieve the above-mentioned objects, a mobile multimedia display apparatus comprises at least one elevating device having a plurality of monitors attached thereon for adjusting the height of the monitors by using the elevating device such that the related message can be outward transmitted via the monitors.

The aforementioned objects and advantages of the present invention will be readily clarified in the description of the preferred embodiments and the enclosed drawings of the present invention.

### BRIEF DESCRIPTION OF THE DRAWINGS

FIG. 1 is a three-dimensional view showing a first preferred embodiment of the present invention.

FIG. 2 is a schematic view showing the usage of the first preferred embodiment of the present invention.

FIG. 3 is a schematic view showing another usage of the first preferred embodiment of the present invention.

FIG. 4 is a three-dimensional view showing a second preferred embodiment of the present invention.

### DETAILED DESCRIPTION OF THE PREFERRED EMBODIMENT

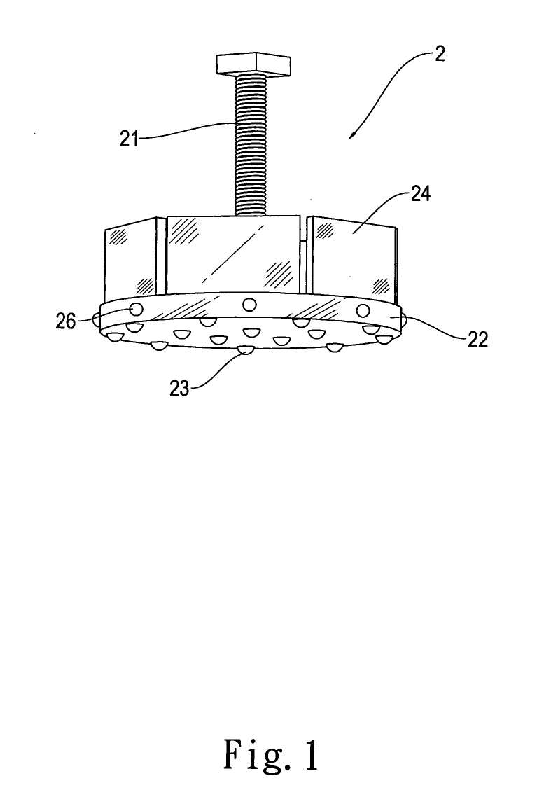

Referring to FIG. 1, a mobile multimedia display apparatus of the present invention comprises an elevating device 2 consisting of an expandable elastic tube 21 and a plate body 22. Several halogen lamps 23 are disposed on the bottom surface of the plate body 22. Several outward-facing monitors 24 are attached to the top surface of the plate body 22. In addition, several light-emitting diodes 26, which are capable of emitting at least two different-colored lights, are attached to the edge of the plate body 22.

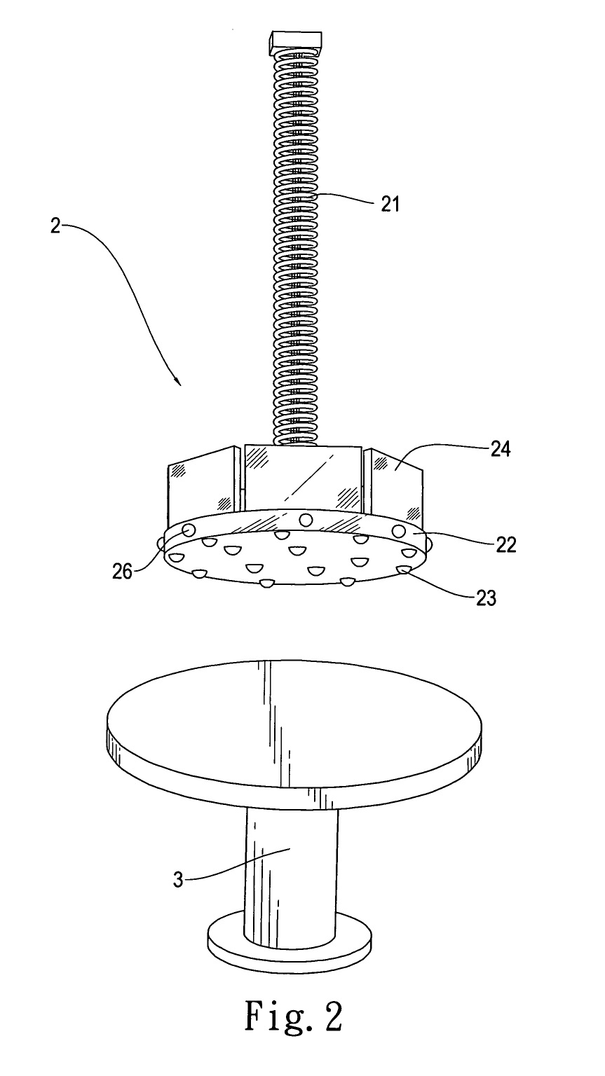

Referring to FIG. 2, the expandable elastic tube 21 that locates above a table 3 has a first end connected to the plate body 22 and a second end connected to the ceiling or awning such that the plate body 22 can be adjusted to a proper height by expanding or contracting the expandable elastic tube 21. Accordingly, the lights emitted from the halogen lamps 23 make the dishes on the table 3 more beautiful and attractive. In addition, the luminosity of lights can be controlled to conform to the atmosphere of dining. Moreover, the users sat around the table 3 can watch the programs distinctly via the monitors 24 such that the users can be provided with additional visual entertainment while they are eating the dishes. In addition, when the users are engrossed in the programs shown on the monitors 24, the light-emitting diodes 26 can emit two different-colored twinkling lights to remind the users at the moment when the content of programs shown on the monitors 24 are changed or when the new dish is being placed.

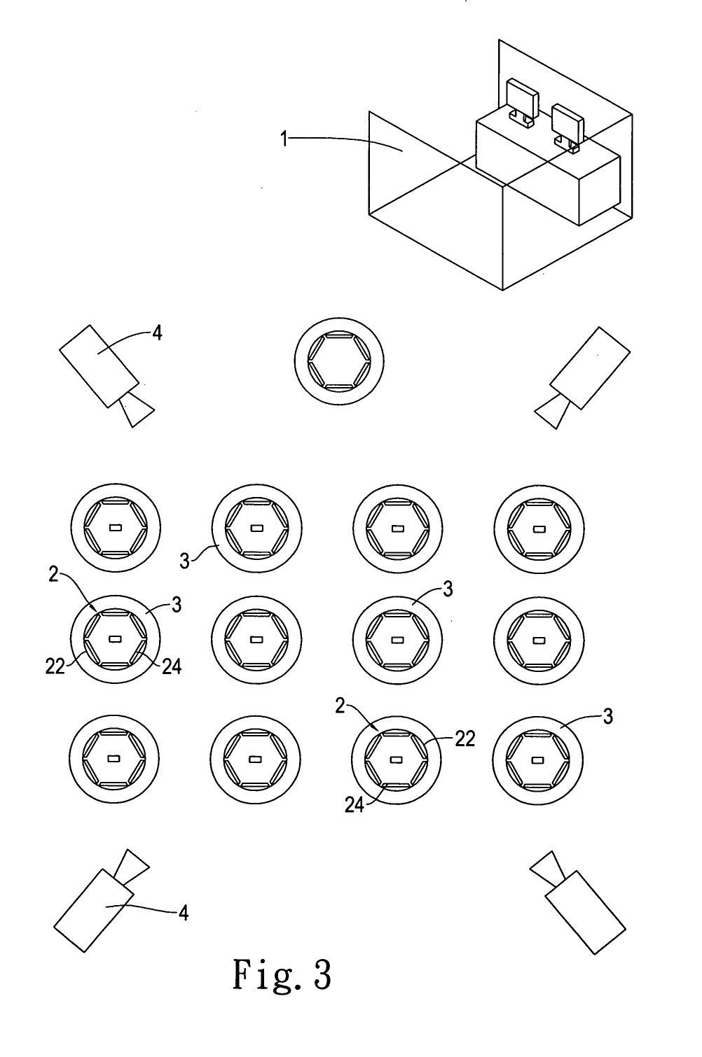

Referring to FIG. 3, the mobile multimedia display apparatus of the present invention is applied to a feast restaurant. In this restaurant, several elevating devices 2 are disposed above respective tables 3. Several cameras 4 are disposed on the periphery of the restaurant. Besides, this restaurant further has a control room 1, wherein several monitors 24 of these elevating devices 2 and these cameras 4 are collectively connected to the control room 1. For example, when a wedding feast is celebrated at this restaurant, the control room 1 can show the newlyweds' wedding photos on the monitors 24 of the elevating devices 2, which are disposed above the respective tables 3 to enable the guests to most distinctly watch these wedding photos. As a result, the above-mentioned conventional problem that the guests cannot easily, distinctly watch the wedding photos can be overcame effectively. When the wedding feast begins, the control room 1 replaces the wedding photos displayed on all of the monitors 4 with the images of wedding scene, which are captured by one of the cameras 4, thereby enabling these guests to attach themselves to the wedding feast for further improving the atmosphere of the wedding feast.

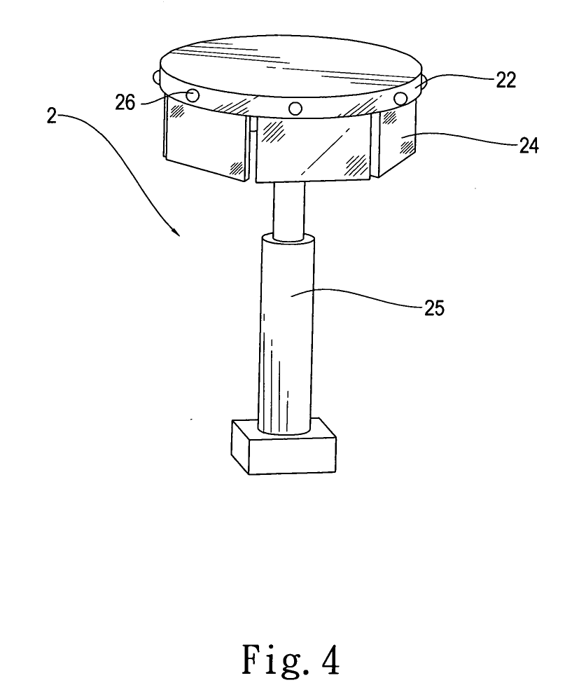

In addition, as shown in FIG. 4, the elevating device 2 alternatively comprises a plate body 22 and an expandable elastic tube 25 attached to the bottom of the plate body 22. Several outward-facing monitors 24 are attached to the bottom edge of the plate body 22. As a result, the monitors 24 disposed on the bottom edge of plate body 22 can be adjusted to a proper height by expanding or contracting the expandable elastic tube 25 to enable the users to watch them conveniently.

In accordance with the foregoing description, it is apparent that the present invention provides the advantages as follows:

1. The monitors disposed on the plate body can be adjusted to a proper height by ascending or descending the elevating device.

2. The conventional problem that the guests cannot easily, distinctly receive the messages shown on the projector can be overcame so as to effectively inform every guest of the messages from the sponsor.

3. The present invention protects the attendees from boring waiting by providing them with another entertainment and brings additional income by showing advertisements.

In summary, the present invention indeed achieves the expected objects by disclosing a mobile multimedia display apparatus that is easily viewable and is not limited by the landform. Accordingly, the present invention meets the requirement for patentability and is therefore submitted for a patent.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments, which do not depart from the spirit and scope of the invention.

What the invention claimed is:

1. A mobile multimedia display apparatus comprising:
at least one elevating device having a plurality of monitors attached thereon for adjusting the height of the monitors by using the elevating device such that a related message can be outward transmitted via the monitors.

2. The mobile multimedia display apparatus of claim 1, wherein the elevating device is composed of an expandable elastic tube and a plate body, and the monitors are outward-facing and attached to the top of the plate body.

3. The mobile multimedia display apparatus of claim 1, wherein the elevating device is composed of an expandable elastic tube and a plate body, and the monitors are outward-facing and attached to the bottom of the plate body.

4. The mobile multimedia display apparatus of claim 1, wherein the elevating device is connected to a control room.

5. The mobile multimedia display apparatus of claim 4, wherein the control room is connected to a plurality of cameras.

6. The mobile multimedia display apparatus of claim 1, wherein a plurality of light-emitting diodes, which are capable of emitting at least two different-colored lights, are attached to the edge of a plate body of the elevating device.
